(19) United States
(12) Patent Application Publication
(10) Pub. No.: US 2009/0030355 A1
(43) Pub. Date: Jan. 29, 2009

(54) Hydrotherapy Apparatus for a Lower Extremity

(76) Inventor: Brian Gay, Victoria (AU)

Correspondence Address: Ralph A. Dowell of DOWELL & DOWELL P.C., 2111 Eisenhower Ave, Suite 406, Alexandria, VA, 22314, US

(21) Appl. No.: 11/665,056

(22) PCT Filed: Oct. 11, 2005
(86) PCT No.: PCT/AU2005/001577

§ 371 Date: Mar. 14, 2008

(30) Foreign Application Priority Data
Oct. 11, 2004 (AU) 2004905866
Oct. 11, 2004 (AU) 2004905867

(51) Int. Cl. A61H 9/00

(52) U.S. Cl. 601/166; 601/160

(57) ABSTRACT

The present invention provides a hydrotherapy apparatus (10) useful for treating the lower extremities of a user, including the feet, lower legs, thighs, pelvis, and waist. The apparatus includes means for controlling fluid (16) sloughed from the lower extremity, such as that from washing the foot before a pedicure treatment, to prevent contamination of the hydrotherapy vessel (11). The apparatus may also be adapted to cover at least a portion of the fluid surface to prevent loss of water from the vessel.

### FIELD OF THE INVENTION

The present invention relates to an apparatus used in the provision of health and beauty treatments by hydrotherapy to the lower extremities, including the foot, leg, thigh, pelvis or waist.

### BACKGROUND

Hydrotherapy has been used since ancient times to prevent, ameliorate, or cure many ailments of the human body. While hydrotherapy may be used to treat specific ailments, it may also be implemented simply for relaxation purposes.

Lower regions of the body such as the feet, legs and pelvis are known to benefit from hydrotherapy. The application of massage and heat to the body of a user is known to increase macro- and microcirculation leading to increased oxygen and nutrient delivery to tissues, and enhanced removal of toxins. Enhancing circulation can be particularly important in the body extremities. Given the distance of the extremities from the heart, and the high resistance provided by the capillary beds, the hands and feet are especially vulnerable to low blood flow. An extreme example of this is seen in users suffering diabetes where there is a progressive breakdown of the peripheral vasculature, leading to decreased blood flow to the hands and feet.

Massaging the extremities is also important since these regions are the sites of many musculoskeletal injuries. For example, muscle strains and sprains in sports persons often occur in the knees, hips and ankles, as well as the major muscle groups of the legs.

One form of hydrotherapy is that of pedicure, where the feet and lower legs are soaked in water to enhance the health and beauty of these parts of the body. Pedicure maintains the feet in good condition making the skin soft and smooth.

It improves blood circulation, nourishes the skin and the leg and foot muscles and discourages foot ailments.

The application of water is known to have many positive effects on the feet. Firstly, water cleans the feet to remove dirt and oils. This can be important where the lower extremities are later treated with lotions, oils or medicaments since these agents penetrate the skin of the feet more efficiently once dirt and oils are removed. The feet may also be soaked in water to soften the skin making it easier for lotions, oils or medicaments to penetrate the skin. The skin of the feet can become very hard and roughened and it is difficult for substances to pass through the rough, horny layer of dead keratinocytes on the surface of feet. Softening the skin also facilitates the removal of toughened skin by exfoliative techniques, and to trim the cuticles of the toe nails. Hydrating the toenails also allows for easier cutting of the nails.

Hydrotherapy is also known to be beneficial for other parts of the lower body including the upper legs, and even the pelvic region. These parts of the lower body are often the site of aches and pains, especially after sporting activities relying on running such as football and tennis that rely heavily on the muscles of the upper leg. Hydrotherapy is also able to relieve pain in muscle groups higher than those of the legs. For example, sports such as basketball rely heavily on jumping motions utilising the gluteus maximus muscles.

The prior art provides a number of apparatuses useful in administering hydrotherapy to the lower regions of the body. For example, users at home may often simply use a bucket, basin, tub or other suitable vessel commonly found in the home. The prior art also provides a number of purpose-built apparatuses that afford advantages over a simple water holding vessel. An example of a “foot spa” apparatus for use in the home is the model DR 6621 marketed under the brand Dr Scholl (Schering-Plough Healthcare Products Inc, Kenilworth N.J.). This apparatus includes a vessel for receiving the feet, a heater to warm the water, and acupressure rollers to massage the feet. A more sophisticated device is the model FB15N marketed by Conair (Stamford Conn.) which includes water jets to massage the feet and a remote control.

Purpose-built pedicure apparatus are also known in the professional market. These devices are generally more substantial than their domestic counterparts, and may include a padded seat with arm rests. An example of a professional apparatus useful in a commercial setting is the SpaMate Legend AMS500D (marketed by Pedicure Chair of Corona Calif.) which is of unitary design incorporating a padded chair and computer control of parameters such as water temperature, duration of treatment, drainage of water etc.

However, both professional and domestic pedicure apparatus have a number of disadvantages. One disadvantage is that these apparatuses cannot be filled close to capacity, and often include only a shallow pool of water at the bottom of the vessel. If prior art apparatuses were to be filled close to capacity, significant amounts of water would be lost from the vessel through the vigorous action of spa jets located in the apparatus (if present), or by the movement of the user's lower body, causing spillage.

One limitation of hydrotherapy apparatuses is that they are able to treat only the foot and the lower calf while the user is seated. There is no ability to treat a leg up to the knee of a seated person given the problem of water spillage, with water loss being a greater problem still where a massaging jet is required close to the knee.

Another problem concerns maintaining the cleanliness of hydrotherapy apparatuses for the lower body. A particular issue is that of cross-infection between subsequent users of a pedicure apparatus. The feet especially harbour a range of bacteria, viruses and fungi which are capable of being transmitted from one user to another unless the vessel is scrupulously drained and cleaned after each use. Repeated cleaning is labour intensive and wastes large volumes of water, especially in commercial models.

A further problem is that during a hydrotherapy treatment, the water quality can diminish rapidly. This is especially the case if the user has undergone waxing, exfoliation, or a mud treatment before or during the hydrotherapy session. It will be appreciated that the water will become contaminated with hair, dead skin cells, remnants of wax and the like resulting in the user essentially soaking in unclean water. Cleanliness is of even greater concern to a subsequent user of the apparatus where the water is not changed between users, or where the water is changed but extensive decontamination is not implemented.

It is an aspect of the present invention to overcome, or at least partly alleviate some of the problems of the art and provide a hydrotherapy apparatus that is adapted to treat anatomical regions higher than the lower leg, minimise the loss of water during use, minimise wastage of water for cleaning, or to minimise cross infection.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention before the priority date of each claim of this application.

### SUMMARY OF THE INVENTION

In a first aspect, the present invention provides a hydrotherapy apparatus for treating a lower extremity of a user including a vessel adapted to retain a fluid, the vessel having an opening adapted to receive a lower extremity or part thereof thereby allowing the user to contact the fluid, wherein the vessel includes means for controlling a fluid that has sloughed from the lower extremity.

The present invention provides a number of advantages over hydrotherapy apparatuses disclosed in the prior art. The ability of the apparatus to control fluid sloughing from the feet allows the feet of the user to be cleansed before immersion in the vessel. Cleansing before immersion using the apparatus of the present invention minimises the introduction of contaminants into the vessel for two reasons. Firstly, the contaminant load on the foot is significantly lessened before introduction to the water. Secondly, water (and accompanying contaminants) sloughed from the lower extremity during or after cleansing is not allowed to enter the vessel. Instead, the sloughed water is controlled by collection in a recess, for example. In addition to the foregoing, it will be appreciated that once the foot is removed from the vessel after treatment, the apparatus is capable of controlling the water (and accompanying contaminants) sloughing from the feet and reentering the vessel.

The apparatus further prevents contamination of the water in the vessel by substances placed on the foot or legs during a treatment. For example, a user may have their legs waxed and moisturised before pedicure treatment. In pedicure apparatus of the prior art, remnants of wax, hair and moisturiser are washed from the legs and into the pedicure vessel. The user then must bathe in the same water, thereby exposing the feet to undesirable substances. In a preferred embodiment of the present invention, the means for controlling fluid that has sloughed from the lower extremity, or part thereof is, or includes, a recess. The recess typically prevents contamination of fluid in the vessel with the sloughed fluid.

Inclusion of means for controlling fluid in a hydrotherapy apparatus also provides a visual reminder for the therapist to cleanse the feet before immersion in the vessel. It also encourages the therapist to wash their hands before, during or after a treatment since they may do so and allow water sloughed from their hands to be collected by the means for controlling fluid. Again, this assists in maintaining the water in the vessel in as clean a state as possible.

Apart from limiting the opportunity for cross contamination, maintaining clean water in the vessel has the advantage of saving water. Water is clearly a limited and precious resource in many countries, and hydrotherapy apparatuses (and especially commercial models) consume vast amounts of water. As will be appreciated, given the inevitable contamination of water in hydrotherapy vessels of the prior art they must be emptied and refilled at regular intervals to maintain cleanliness. In light of the contamination, they must also be vigorously cleaned and disinfected at regular intervals. Given that the apparatus of the present invention allows water to be re-used many times before changing, substantial savings in water consumption are achieved.

The means for controlling fluid may be integral to the apparatus. For example, the means for controlling the fluid may be a recess that forms a part of the apparatus, such as an inwardly or outwardly inclined recess extending from at least a portion of the rim of the vessel or from at least a portion of the rim of the opening adapted to receive the lower extremity or part thereof.

Alternatively, the means for controlling fluid may be formed as a separate component. For example, the means for controlling fluid may be a recess that is connected to the apparatus, either during manufacture or prior to use. The connection may be achieved by an adhesive, heat-sealing, crimping or any other method able to provide an appropriate connection of the recess to the apparatus. It will be appreciated that where the recess is formed as a separate component to the apparatus, the recess may be removed for cleaning, repair or replacement.

The means for controlling fluid may simply be inherent in the shape of the recess itself. For example, the recess may be shaped such that fluid conveniently collects at the lowest point of the recess. Alternatively, the means for controlling the fluid may be a depression in the recess. For example, a low point in the recess could be expanded so that it is able to retain the fluid.

In a further preferred embodiment of the present invention, the means for controlling fluid is, or includes, an absorbent material such as a sponge or a towelling fabric incorporated into the structure of the vessel.

In another preferred embodiment of the present invention, the means for controlling the fluid is, or includes, a drainage aperture in the recess capable of draining fluid from the recess. Preferably, the drainage aperture drains the fluid away from the vessel, such as into a waste tank.

Preferably, the recess that is shaped to conform substantially to that part of the lower extremity that is received by the recess. For example, the recess may include at least one depression that is configured to receive the lower part of a foot and provide appropriate comfort to the user when the foot is placed thereon. Typically, where the lower extremity is a foot, the recess may include at least one substantially concave depression therein.

Alternatively, the apparatus of the present invention may include a means for receiving at least one lower extremity, or part thereof, that is distinct from the means for controlling fluid. For example, the means for receiving at least one lower extremity, or part thereof, may include at least one other recess, such as a footrest, onto which the lower extremity, or part thereof, is placed when removed from the vessel. Typically, the at least one other recess is in communication with the means for controlling fluid so as to control fluid that has sloughed from the lower extremity, or part thereof, when placed onto the at least one other recess. For example, the means for receiving at least one lower extremity or part thereof includes a footrest positioned over the means for controlling fluid, such that fluid sloughed from the lower extremity, or part thereof, is collected onto the means for controlling fluid positioned below the footrest.

Typically, the lower extremity includes at least one foot. Preferably, the lower extremity includes a foot and a lower leg which may extend up to and including a knee. The lower extremity may extend to the thigh, hip or waist.

The means for controlling fluid that has sloughed or dripped from the lower extremity typically minimizes cross-contamination of the fluid within the vessel with fluid that has sloughed or dripped from the lower extremity of the user. This represents an important advantage over commercial prior art hydrotherapy apparatuses, which typically use an average of 100,000 to 200,000 litres of water per year by draining and re-filling. Thus, by providing a means of minimizing cross-contamination of the fluid in the vessel between users, the fluid applied to the present invention can be reused for longer period, saving up to 90% of fluid loss by draining and re-filling.

Typically, the fluid is a liquid such as water. However, while water is a preferred liquid to be used in the vessel, the use of other liquids is also contemplated. For example, water including one or more solutes (e.g. salt) could be used. Also included could be mud, gels or semi-gel materials, silicones and the like. The fluid could also include a substantially non-aqueous substance such as sand, powders and the like. The use of different fluids to fill the vessel may provide differing sensations and therapeutic effects.

The hydrotherapy apparatus of the present invention may further include a means of sanitizing the fluid, such as by chlorination, ultra-violet radiation, ozone or iodine. Sanitization of the fluid may be performed prior to filling of the vessel or may be performed subsequent to use for the purposes of preparing the fluid for subsequent users. The sanitization may also be performed during use, for example, where the fluid is recirculated to and from an external storage tank. The apparatus may also have provision for filtration to remove particulate contaminants. Suitable filtration methods include sand filters, cartridge filters and the like.

The contact of the lower extremity of a user with the fluid may be by direct contact or indirect contact. As used herein, the term “direct contact” means the lower extremity is in physical contact with the fluid. As used herein, the term “indirect contact” means that a barrier is interposed between the lower extremity and the fluid such that physical contact is not made between the fluid and the lower extremity. Accordingly, the present invention includes embodiments whereby the lower extremity never makes physical contact with the water in the vessel by the provision of a disposable sheath. Alternatively, the sheath may be permanent, and the user could place a covering over the lower extremity before placing it into the sheath. The covering could be fluid-tight or absorbent. After use, the covering may be disposed of leaving the sheath untouched by the lower extremity. This will be of greatest advantage in the commercial use of pedicure apparatuses that are used by many individuals and the risk of cross contamination is greatest.

The sheath may be any flexible material that allows the user to feel the hydrodynamic pressure of the surrounding fluid.

It is further preferred that the flexible material has sufficient heat transfer properties so that the lower extremity of the user may be warmed or cooled as necessary. For example, where the sheath is a multiwalled structure, the temperature of the fluid in the jacket may be altered by varying the temperature of the fluid entering and/or exiting the jacket. The movement of the fluid may be facilitated by a pump or by mains pressure (e.g. where the fluid is water). Typically, the alternating temperature of the fluid in the jacket (e.g. between hot and cold) provides a pleasurable sensation to the user. It is generally considered that the more rapid the variation in temperature of the fluid in the jacket, the more pleasurable the sensation experienced by the user.

The sheath may be a sheet-like plastic or material such as sail cloth.

In a particularly preferred form of the present invention, the sheath is also resilient. Examples of flexible and resilient sheath materials useful in the present invention include any natural or synthetic rubber including but not limited to nitrile rubber, silicone rubber, fluoro-silicone rubber, butyl rubber, polybutadine rubber, neoprene rubber, hypalon, EPDM, viton, polyurethane, latex, polyvinyl chloride and polyethylene.

The sheath may also be a composite of any of the materials disclosed herein.

It will be appreciated that it is only necessary for a portion of the walls of the sheath to be composed of a flexible material, though preferably the entire sheath is composed of a flexible material.

Where the sheath is not integral with the vessel, it may be attached in such a way as to be replaceable. Accordingly, the present invention also includes a replacement sheath alone that may be sold as a consumable item. It will also be understood that existing hydrotherapy apparatuses may be retrofitted with a sheath as described herein. Accordingly, the present invention includes a sheath composed of a flexible material adapted to be attached to an existing apparatus.

The sheath may be any shape capable of receiving a required lower extremity. In a preferred embodiment, the sheath is generally cylindrical. It is contemplated that more than one lower extremity may be treated. For example, the sheath may be shaped like a pair of trousers where the user inserts both legs, and even the pelvis into the cavity.

In another form of the present invention, the sheath is quite short, for example, where a foot is to be treated. For the treatment of a foot, the sheath may be substantially sock-shaped. For the treatment of a foot and calf, the sheath may be substantially boot-shaped.

The use of a sheath between the user and the water provides a number of benefits. Implementation of “dry treatments” by the apparatus of the present invention more easily allows for the provision of treatments in public places such as airports, shopping centres and the like. People are often embarrassed to remove their socks in public places due to problems of foot odour and unsightly conditions such as corns, bunions, and ingrown toe nails. Even if the person could be persuaded to remove their socks, there is the inconvenience of having to dry the feet after treatment.

Implementation of dry treatments also provides another significant advantage where the apparatus is a completely sealed unit, in that it can be inclined on any angle without any loss of fluid. This allows the administration of a treatment where the user is reclining, or even sleeping. A user could therefore experience a treatment when reclining on an airplane, or lying prone during a massage session. Sports injuries can require treatments of many hours duration, often extending into sleep periods. Use of the apparatus of the present invention will allow an athlete to sleep in a horizontal position while still undergoing treatment.

An advantage provided by embodiments including a sheath is that the means for controlling water more easily allows for cleansing and treatment of the extremity in preparation for insertion into the membrane. An exfoliation could be administered prior to the application of oils, medicaments and the like to the extremity. The extremity is then placed into the membrane, with the temperature and pressure of the surrounding water being transferred to the extremity via the membrane. The temperature and pressure then acts to assist in the penetration of the oil or medicament into the skin.

In another aspect, the present invention the present invention provides a hydrotherapy apparatus for treating a lower extremity including a vessel adapted to retain a fluid, the vessel having an opening adapted to receive a lower extremity thereby allowing the user to contact the fluid, wherein the opening has a shape and/or size such that at least a portion of the fluid surface is covered.

Thus, the apparatus is configured to cover at least a portion of the fluid surface, thereby reducing the amount of fluid loss from the vessel through splashing or movement of the body of fluid within the vessel. To the best of the Applicant's knowledge, the prior art is devoid of a hydrotherapy apparatus that is capable of minimising water loss by providing at least a partial cover over the water surface such that the user is free to move or use high pressure spa jets when the vessel is substantially full.

Splashing can result from the movement of the user's lower extremity(ies) within the vessel. For example, in prior art apparatus which typically include a vessel with an opening at the top, if the vessel is filled with fluid so that the fluid surface is close to the opening of the vessel, then movement of the lower extremity can lead to fluid spilling from the vessel. If spa jets are fitted to the vessel, fluid can also be lost through turbulence.

Another advantage of at least partially covering the fluid surface is that greater pressures and flow rates in terms of fluid recirculation (if fitted) may be achievable, as compared with an apparatus of the prior art. This may allow for very high flow rates and/or pressure from the circulating means without the problem of spillage. In some forms of the invention, the pressure may reach over 2 bar, and more preferably over 4 bar. These very high pressures increase the hydrodynamic pressure on a lower extremity placed inside the vessel, providing a superior massage. As mentioned, high flow rates (in the absence of high pressure) can lead to fluid loss. In terms of flow rates it is contemplated that a flow rate in excess of 100, 200, 300 or 400 litres per minute could be problematic in terms of fluid loss, and will benefit from an apparatus as described herein.

Another advantage of at least partially covering the fluid surface is that substantially reduced aerosols are generated, this being a problem especially where there is vigorous recirculation of the fluid. It is known that aerosols can carry very serious pathogens. An infamous example is that of Legionella species (the aetiologic agent of Legionnaires' disease) which are spread by aerosols generated in air conditioning cooling towers. The closed or partially closed nature of the apparatus of the present invention reduces the establishment of an air/fluid interface, and therefore the generation of aerosols.

In a further preferred embodiment of the present invention, the internal dimensions of the vessel is adapted to receive the lower extremity up to at least the knee, thigh, pelvis or waist. Accordingly, the internal dimensions of the vessel may define a height of at least about 40 cm, more preferably at least about 80 cm and still more preferably at least about 100 cm. For taller individuals it is contemplated that a height of at least about 120 cm may be required for immersion up to the waist. The hydrotherapy apparatus of the present invention is therefore adapted to provide a vessel of sufficient depth to allow exposure of a leg directly or indirectly to fluid within the vessel all the way up to the knee. This is not possible with existing apparatuses, since a vessel filled with fluid, such that the fluid level is substantially at the level of the knee, will spill from the opening at the top of the vessel. The user is often seated with his or her legs bent at the knee, such that the opening at the top of the vessel is no higher than the knee. If the leg of the user is submerged all the way up to the knee, then this clearly requires that the vessel be filled with fluid all the way up to the opening at the top of the vessel. Accordingly, in this position it is not possible for the walls of the vessel to be any higher to prevent spillage of fluid.

The vessel typically covers at least about 20% of the fluid surface although may cover the entire fluid surface. Where the vessel covers the entire fluid surface, it will be understood that at least one aperture is provided to allow at least one lower extremity of the user to be admitted into direct or indirect contact with the fluid. A single aperture could be included. More preferably, two apertures could be included, one for each lower extremity.

The at least one aperture may be provided with an aperture cover. The aperture cover can be positioned to close the aperture when there is no extremity in the aperture in order to maintain cleanliness of fluid in the vessel. The aperture cover may also provide a surface over which a hand shower or similar device can be used to wash the feet and/or legs of a user. Typically the aperture cover is adapted to direct any washing fluid away from the aperture. The washing fluid may be collected via a drainage channel preferably into a waste tank. In a preferred embodiment, the aperture cover includes a resilient membrane having a slit that is adapted to allow a lower extremity to pass therethrough. For example, when there is no lower extremity in the vessel, the resilient membrane is biased towards a closed position, preventing foreign substances (such as fluid that has sloughed from the user's lower extremity) from entering the vessel and contaminating the fluid therein. The closed position also prevents loss of fluid from within the vessel through splashing or evaporation. Upon entry of a lower extremity into the vessel through the slit, the resilient membrane deforms to accommodate the lower extremity passing through the slit. However, due to the bias of the resilient membrane towards the closed position, the space between the surface of the lower extremity and the vessel cover is minimised, thus resisting contamination of the fluid within the vessel by a foreign substance and/or the loss of fluid from the vessel as a result of splashing or evaporation. It is contemplated that the slit may form a more complete seal around the lower extremity by the incorporation of an inflatable cuff around the edge of the slit. The cuff would be substantially deflated at first to allow admission of the users extremity, and once the extremity had pass through the slit the cuff could be inflated to form a substantially fluid-tight seal around the extremity.

Typically, the apparatus of the present invention will also include means for circulating fluid inside the vessel. In a preferred apparatus, the means for circulating fluid will be the type of jet typically used in spa baths or swimming pools. The skilled person will be able to select an appropriate model of jet from those available to the trade. In a preferred form of the invention, the jet is a high flow jet or a high pressure jet. While any number of jets may be included, the apparatus will typically have about eight jets. It is the movement and pressure of the circulating fluid that is generally responsible for providing the massage effect of the hydrotherapy apparatus. Accordingly, in one form of the invention that the jets are directed towards the centre of the vessel. Of course, the skilled person will be able to arrange the direction and intensity of the jets to achieve a desired result by routine means. In another form of the invention, the jets are directed toward the centre of the vessel from a lateral or circumferential position, and are directed toward the centre from a position inferior to the centre. In a further preferred form of the invention the jets are directed to the lower leg at a point just below the knee. It is further contemplated that moving jets are included in the apparatus, such that a single jet is capable of massaging a number of regions of the extremity.

Where the vessel covers at least a substantial portion of the fluid surface and is adapted to receive a lower extremity extending at least from the foot to the knee, higher spa jet pressure and fluid movement can be accommodated than in prior art apparatus.

In a further preferred embodiment of the present invention, the vessel cover is formed of a resilient membrane attached to the vessel, the resilient membrane further comprising at least one slit through which a lower extremity may pass upon entry into the vessel.

Typically, the resilient membrane is made of a rubber-like material such as a natural or synthetic rubber, a plastic such as polyvinyl chloride, or a woven material including sail cloth and the like. The resilient membrane may also be made of a material including but not limited to nitrile rubber, silicone rubber, fluoro-silicone rubber, butyl rubber, polybutadine rubber, neoprene rubber, hypalon, EPDM, viton, polyurethane, latex, and polyethylene.

Similarly, where the vessel covers only a portion of the fluid surface, the opening may be provided with an aperture cover. The opening cover can be positioned to close the opening when there is no lower extremity in the opening in order to maintain cleanliness of fluid in the vessel. The opening cover may also provide a surface over which a hand shower or similar device can be used to wash the feet and/or legs of a user. Typically, the opening cover is adapted to direct any washing fluid away from the opening. The washing fluid may be collected via a drainage channel preferably into a waste tank.

The hydrotherapy apparatus of the invention may permit fluid heated to a higher-than-ambient temperature to be maintained in the vessel without significant loss of fluid, for example, through evaporation. This is particularly so when at least one aperture cover or a vessel cover is provided. However, where the vessel cover covers the entire fluid surface and the fluid within the vessel is heated, the temperature of the fluid may rise beyond a level that is comfortable for the user because there is limited opportunity for heat loss to the atmosphere. Accordingly, the apparatus of the present invention may be provided with a means for controlling the temperature of the fluid within the vessel. For example, the apparatus may include a heat exchanger.

It should be understood that it is not strictly necessary to incorporate means for circulating fluid in the apparatus. For example, the vessel could simply be filled with fluid (warm, body temperature, or cold) that in itself will provide certain therapeutic effects. It would also be possible to increase or decrease the pressure of the fluid in the vessel, or the air surrounding the fluid in the vessel (where the vessel is sealed), or alternately increase and decrease the pressure of the air and/or fluid to provide a pulsating effect. Where the apparatus includes a sheath, the change in pressure will be translated to the wall(s) of the sheath, and in turn to the extremity of the user.

In a preferred embodiment of the present invention, the configuration of the vessel to cover at least a portion of the fluid surface also provides a means for controlling fluid. For example, the means for controlling fluid may be a depression in a cover defining an inwardly inclined recess extending over the surface of the fluid, or a portion thereof, from the lip of the vessel. The means for controlling fluid may also include an absorbent material. The means for controlling the fluid may also include a drainage aperture.

In yet a further preferred embodiment of the present invention, the configuration of the vessel to cover at least a portion of the fluid surface also provides a means for receiving a lower extremity or part thereof. For example, the vessel may be configured to include an inwardly inclined recess extending from at least a portion of the rim of the vessel, wherein the recess is adapted to receiving a lower extremity, or part thereof. The recess may be shaped to conform substantially to that part of the lower extremity that is received by the recess. For example, the recess may be provided with at least one depression that is configured to receive the lower part of a foot and provide appropriate comfort to the user when the foot is placed thereon. Where the lower extremity is a foot, the recess may include at least one substantially concave depression therein.

It would be understood by a person skilled in the art that the configuration of the vessel to cover at least a portion of the fluid surface may provide a means for receiving a lower extremity or part thereof, as well as a means for controlling fluid sloughed from the lower extremity or part thereof.

The apparatus of the present invention may be of a unitary design, being fabricated as one piece, such that the means for receiving at least one lower extremity or part thereof and/or the means for controlling fluid sloughed from the lower extremity or part thereof are integral to the apparatus.

When present, the vessel cover which covers retained fluid is fabricated separately and subsequently joined to the vessel. The joining may be achieved by an adhesive sealant, heat sealing, crimping or any other method able to provide a substantially fluid tight seal.

The vessel cover may be attached in such a way as to be replaceable. Accordingly, the present invention also includes a replacement vessel cover for an apparatus of the invention that may be sold as a separate consumable item. It will also be understood that existing foot spas may be retrofitted with a vessel cover. Accordingly, the present invention includes a vessel cover adapted to be attached to an existing foot spa.

Typically, the walls of the vessel not concerned with receiving lower extremities are substantially rigid, and may be composed of a material such as fibreglass or a rigid plastic, metal, glass or wood.

The hydrotherapy apparatus of the present invention may include means for heating or cooling the fluid contained in the vessel. A heat exchanger can be used to counteract heating of the water due to passage through the pump.

It is contemplated that the vessel of the apparatus may be connected to one or more storage tanks, each having means for transferring the contents of the storage tank to or from the vessel. The storage tanks may be used simply to store fluid, to pre-heat fluid or pre-cool fluid. It is also contemplated that the storage tanks could be used to achieve a rapid change in temperature of fluid contained in the vessel. For example, if in the first instance the vessel contained warm fluid, the temperature of the fluid could be rapidly changed by draining warm fluid and admitting cooler fluid stored in a storage tank. In an embodiment of the invention, the vessel is connected to two storage tanks, this allowing rapid oscillation of water temperature in the vessel. In use, fluid having a first temperature in the vessel is drained into a first storage tank, followed by the admission of fluid having a second temperature from a second storage tank. The fluid having the second temperature is then drained into the second storage tank and fluid having the first temperature readmitted into the vessel. This cycle may be repeated as often as desired to produce rapid temperature cycling in the vessel.

The cover may include a flexible membrane sheath, as described supra. In this way, the unit becomes completely sealed. Thus, the fluid is exposed to neither the skin of a user or the atmosphere. Implementation of “dry treatments” using a completely sealed unit provides a significant advantage in that the entire hydrotherapy apparatus can be inclined on any angle without any loss of fluid. This allows the administration of a treatment where the user is reclining, or even sleeping. A user could therefore experience a treatment when reclining on an airplane, or lying prone during a massage session. Sports injuries can require treatments of many hours duration, often extending into sleep periods. Use of the apparatus of the present invention will allow an athlete to sleep in a horizontal position while still undergoing treatment.

Another advantage is that the fluid in the vessel can be reused. Existing hydrotherapy apparatuses must be completely drained for every user, leading to the wastage of around 30 to 40 litres of fluid. If the fluid has been treated with a biocide, it is possible that the same fluid could be used for days, weeks or months before draining the vessel, particularly where a sheath is provided to cover the lower extremity to be admitted into the vessel. It is further contemplated that the lower extremity could be cleansed with a biocide before immersion in the vessel.

Furthermore, the problem of aerosols carrying bacteria to the atmosphere as mentioned supra is completely obviated.

The use of storage tanks as described supra may also facilitate the admission and or removal of a lower extremity where the apparatus incorporates a sheath adapted to receive a lower extremity. Due to hydrostatic pressure on the walls of the sheath, some users may experience difficulty in inserting or removing a lower extremity into the sheath when the vessel is full of water. This problem could be overcome by removing the water and storing it in a separate tank while the extremity is inserted or removed.

The problem of inserting an extremity into the sheath may also be overcome by at least partially evaginating the sheath before insertion of the extremity, such that the sheath extends outwardly from the vessel interior. The user then inserts the extremity into the outwardly extended sheath and pushes the extremity toward the interior of the vessel such that the sheath invaginates and returns fully to the interior of the vessel.

The apparatus of the present invention may further include seating means for the user. In a preferred embodiment, the seating means is adapted to elevate the user to assist the user in lifting their lower extremities from the vessel or lowering the lower extremity(ies) into the vessel. The seating means may also be capable of swivelling, allowing the user's lower extremities to clear the vessel before lowering the user.

In a second aspect, the present invention provides a method for treating a lower extremity of the user, the method including the use of a hydrotherapy apparatus according to the first aspect of the invention. It will be appreciated that for the first time it is possible to perform hydrotherapy on the upper part of the lower leg, while the user is still seated. The inclusion of means for covering at least a portion of the fluid surface allows spa jets to be positioned such that the upper part of the lower leg is massaged while fluid loss is reduced.

The method for treating a lower extremity or part thereof according to the present invention may include further features such as the use of any skin care substance such as moisturizer, scented oil, seaweed products, mud, salts and the like which are placed directly on the lower extremity or in the vessel or sheath. Given that the fluid in the vessel may be warm, this will assist the skin care substance or medicament to penetrate the skin to leave the lower extremity fragrant and supple. The treatment will also be useful for those suffering bunions, corns, plantar warts and the like that respond well to hydration and softening of the skin.

The method may also include the use of medicaments in a similar manner to that described above. It is contemplated that the absorption of pharmaceutically active substances will be enhanced by the massage and/or heat supplied by the apparatus. Medicaments that may be used in combination with the methods of the present invention include antibacterials, antifungals, antivirals and the like. Such methods will be very helpful for diabetics, for example, who suffer from degeneration of the extremities due to vascular necrotization, leading to subsequent infection.

The method for treating a lower extremity or part thereof according to the present invention may further include the step of using a flexible, fluid tight sheath adapted to receive the lower extremity or a part thereof. When a lower extremity, or a part thereof, is placed into the sheath and inserted into the vessel, the flexible nature of the sheath typically allows the user to experience the hydrodynamic pressure of the surrounding fluid without being directly exposed to the fluid, thereby preventing infection with pathogens that may be present in the fluid. The sheath also prevents cross-contamination of the fluid within the vessel by foreign substances typically found on the surface of the lower extremity. This is particularly so where the lower extremity has been prior treated, for example, with massage oils, ointments and the like.

Where the apparatus of the present invention is used in conjunction with the sheath, it will be appreciated that the means for controlling fluid that has sloughed from the lower extremity is also a reference to a means for controlling fluid that has sloughed from the sheath upon removal of the lower extremity from the vessel

In a particularly preferred form of the present invention, the flexible sheath is resilient.

The sheath may be adapted to prevent the sheath collapsing due to external fluid pressure. This may be achieved by providing a sheath of multiwalled structure having a sheath cavity and in which fluid can be introduced between the walls to hold the sheath cavity open to receive the lower extremity or a part thereof, the fluid being removed once the lower extremity or a part thereof is in position to allow massaging of the lower extremity by hydrostatic pressure from the fluid in the vessel.

The sheath may also have a multiwalled structure capable of receiving a fluid between the walls, or jacket, so as to apply sufficient pressure about the lower extremity placed within the sheath. This allows massaging of the lower extremity by the hydrostatic pressure from the fluid in the jacket. Where the vessel of the present invention holds an amount of fluid, the hydrostatic pressure applied by the fluid in the jacket is capable of contributing to the massaging effect to the lower extremity. However, it can be appreciated that the hydrostatic pressure applied to the lower extremity by the fluid in the jacket is also capable of contributing to the massaging effect in the absence of fluid within the vessel. Thus, the sheath may be any flexible material that allows the user to feel the hydrodynamic pressure of the surrounding fluid. The sheath may be a sheet-like plastic such as polyvinyl chloride or a low density polyethylene.

The fluid introduced into the jacket of the sheath may be the same or different to the fluid within the vessel.

It is further preferred that the flexible material has sufficient heat transfer properties so that the lower extremity of the user may be warmed or cooled as necessary. For example, where the sheath is a multiwalled structure, the temperature of the fluid in the jacket may be altered by varying the temperature of the fluid entering and/or exiting the jacket. The movement of the fluid may be facilitated by a pump or by mains pressure (e.g. where the fluid is water). Typically, the alternating temperature of the fluid in the jacket (e.g. between hot and cold) provides a pleasurable sensation to the user. It is generally considered that the more rapid the variation in temperature of the fluid in the jacket, the more pleasurable the sensation experienced by the user.

In a particularly preferred form of the present invention, the sheath is also resilient. Examples of flexible and resilient sheath materials useful in the present invention include any natural or synthetic rubber including but not limited to nitrile rubber, silicone rubber, fluoro-silicone rubber, butyl rubber, polybutadine rubber, neoprene rubber, hypalon, EPDM, viton, polyurethane, and latex. The sheath may also be a composite of any of the materials disclosed herein.

It will be appreciated that it is only necessary for a portion of the walls of the sheath to be composed of a flexible material, though preferably the entire sheath is composed of a flexible material.

The sheath may be any shape capable of receiving a required lower extremity. In a preferred embodiment, the sheath is generally cylindrical. It is contemplated that more than one lower extremity may be treated. For example, the sheath may be shaped like a pair of trousers where the user inserts both legs, and even the pelvis into the cavity.

In another form of the present invention, the sheath is quite short, for example, where a foot is to be treated. For the treatment of a foot, the sheath may be substantially sock-shaped. For the treatment of a foot and calf, the sheath may be substantially boot-shaped.

The use of a sheath between the user and the water provides a number of benefits. Implementation of “dry treatments” by the apparatus of the present invention more easily allows for the provision of treatments in public places such as airports, shopping centres and the like. People are often embarrassed to remove their socks in public places due to problems of foot odour and unsightly conditions such as corns, bunions, and ingrown toe nails. Even if the person could be persuaded to remove their socks, there is the inconvenience of having to dry the feet after treatment.

Implementation of dry treatments also provides another significant advantage where the apparatus is a completely sealed unit, in that it can be inclined on any angle without any loss of fluid. This allows the administration of a treatment where the user is reclining, or even sleeping. A user could therefore experience a treatment when reclining on an airplane, or lying prone during a massage session. Sports injuries can require treatments of many hours duration, often extending into sleep periods. Use of the apparatus of the present invention will allow an athlete to sleep in a horizontal position while still undergoing treatment.

It is anticipated that the present invention will find use in the treatment of human subjects. However, it is also contemplated that the present invention will be useful in the treatment of animals, as they are similarly afflicted with conditions of the extremities. The invention will be particularly useful in the treatment of race horses and greyhounds, and other animals prone to musculoskeletal injuries.

The present invention will now be described in further detail with reference to the accompanying drawings.

### BRIEF DESCRIPTION OF THE DRAWINGS

FIG. 1 shows an apparatus of an embodiment of the invention in perspective view.

FIG. 2 shows the apparatus of FIG. 1 with a user positioned in the apparatus. The phantom part of the drawing shows positioning of the user's legs and feet in a recess upon removal from the vessel.

FIG. 3 shows a sheath for use in an apparatus of the invention.

### DETAILED DESCRIPTION OF THE PREFERRED EMBODIMENTS

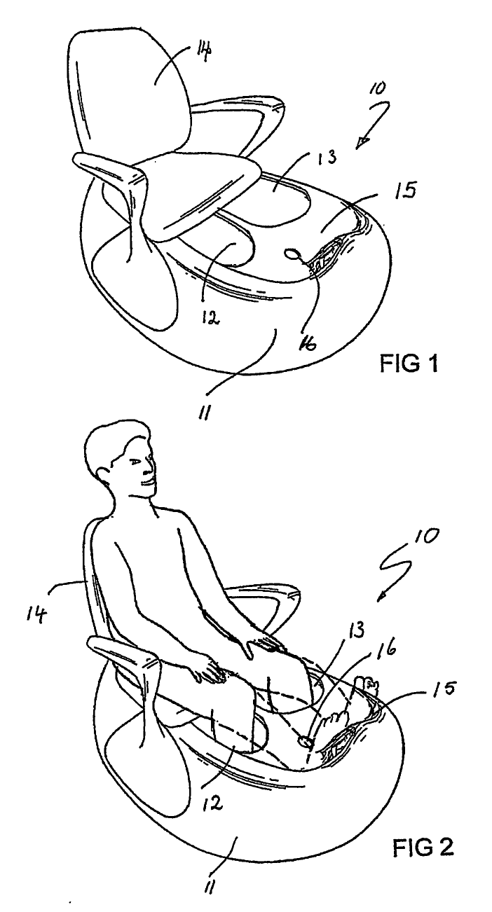

FIG. 1 shows an apparatus of an embodiment of the invention, 10, including a vessel 11. Vessel 11 is adapted to retain a fluid and has paired apertures 12 and 13 each adapted to receive a lower extremity as shown in FIG. 2. The vessel 11 is configured to cover at least a portion of the fluid surface. Apparatus 10 also comprises seating means 14 for the user. Preferably, the seating means 14 is adapted to elevate the user to assist the user in lifting their lower extremities from the vessel 11. Vessel 11 is provided with a recess 15 adapted to receive at least one lower extremity or a part thereof, when removed from vessel 11. The vessel is also adapted to control fluid from sloughing or dripping onto surrounds, or therapist, as shown in FIG. 2. Recess 15 includes means for controlling fluid that has sloughed from the user 16. Means for controlling fluid 16 is a drainage aperture in recess 15 capable of draining fluid from the recess. Preferably, drainage aperture 16 drains the fluid away from the vessel, such as into a waste tank. Thus, means for controlling fluid 16 typically prevents contamination of fluid in vessel 11 with sloughed fluid.

Apparatus 10 also reduces the amount of fluid loss from vessel 11 through splashing. Splashing can result from movement of the user's lower extremity(ies) within vessel 11.

Apertures 12 and 13 may be provided with aperture covers that can be positioned to close the aperture, when there is no extremity in the aperture, in order to maintain cleanliness of fluid in the vessel. The aperture covers may also provide a surface over which a hand shower or similar device can be used to wash the feet and/or legs of a user when seated in a position such as that shown in phantom in FIG. 2.

The present invention also provides methods for treating a lower extremity of a user, the method including the use of an apparatus as described herein. FIG. 2 shows an apparatus 10 of the invention in use. The user is seated on seating means 14 with lower extremities consisting of feet and lower legs introduced into vessel 11 through apertures 12 and 13. In phantom, FIG. 2 shows the user's feet and lower legs removed from apertures 12 and 13 and placed in recess 15 so that sloughed fluid can exit the recess via drainage aperture 16.

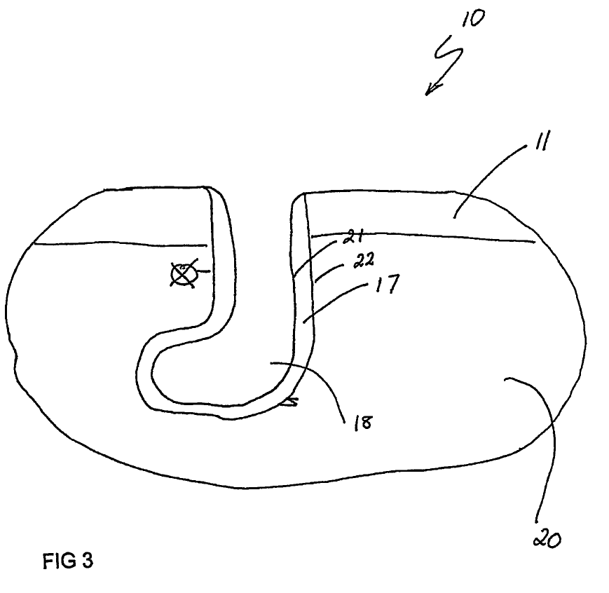

Referring to the embodiment in FIG. 3, the vessel 11 may further include a flexible sheath 17 extending into the vessel. The sheath is adapted to receive the user's lower extremity or a part thereof, into cavity 18 via opening 19 during treatment, after which it is withdrawn via the opening 19. The flexibility of the sheath 17 allows intimate contact with the surface of the lower extremity by virtue of the hydrodynamic pressure of the surrounding fluid 20. The user is therefore exposed to the hydrodynamic pressure of the surrounding fluid without actually being directly exposed to the fluid.

In a preferred embodiment, the sheath 17 includes inner and outer flexible membranes 21 and 22 respectively, wherein the inner membrane 21 is capable of making contact with the lower extremity placed therein, and the outer membrane 22 is in contact with the fluid in the vessel.

In a further preferred embodiment, the sheath 17 is adapted to receive a gas or fluid into the space defined between the inner and outer membranes 21 and 22. When a gas (e.g. air) or a fluid (e.g. water) is placed into the space between the inner and outer membranes of the sheath under a pressure that exceeds that of the fluid within the vessel, the sheath tends to expand to its intended shape. This allows the user to place his or her lower extremity into the cavity 18 with little resistance. Once the lower extremity is placed into the cavity, the pressure of the gas or fluid in the space between the inner and outer membranes of the sheath is reduced so as to allow the sheath to collapse about the lower extremity and allow the user to be exposed to the hydrodynamic pressure of the surrounding fluid without actually being directly exposed to the fluid. Sheath 17 may include a pump 23 for its expansion and a valve 24 for its deflation.

Finally, it is to be understood that various other modifications and/or alterations may be made without departing from the spirit of the present invention as outlined herein.

1. A hydrotherapy apparatus for treating a lower extremity of a user including a vessel adapted to retain a fluid, the vessel having an opening adapted to receive a lower extremity or part thereof thereby allowing the user to contact the fluid, wherein the vessel includes means for controlling a fluid that has sloughed from the lower extremity.

2. An apparatus according to claim 1 wherein the means for controlling fluid is, or includes, a recess.

3. An apparatus according to claim 1 wherein the means for controlling fluid is integral to the apparatus.

4. An apparatus according to claim 2 wherein the recess is an inwardly or outwardly inclined recess extending from at least a portion of the rim of the vessel or from at least a portion of the rim of the opening adapted to receive the lower extremity or part thereof.

5. An apparatus according to claim 2 wherein the means for controlling fluid is inherent in the shape of the recess.

6. An apparatus according to claim 2 wherein the recess is shaped such that fluid collects at the lowest point of the recess.

7. An apparatus according to claim 2 wherein the means for controlling fluid is a depression in the recess.

8. An apparatus according to claim 1 wherein the means for controlling fluid is, or includes, an absorbent material.

9. An apparatus according to claim 1 wherein the means for controlling fluid is, or includes, a drainage aperture.

10. An apparatus according to claim 9 wherein the drainage aperture drains the fluid into a waste tank.

11. An apparatus according to claim 1 wherein the recess is shaped to conform substantially to that part of the lower extremity that is received by the recess.

12. An apparatus according to claim 1 including means for receiving at least one lower extremity, or part thereof, that is distinct from the means for controlling fluid.

13. An apparatus according to claim 12 wherein the means for receiving at least one lower extremity, or part thereof, that is distinct from the means for controlling fluid is a footrest.

14. An apparatus according to claim 13 wherein the footrest positioned over the means for controlling fluid, such that fluid sloughed from the lower extremity, or part thereof, is collected onto the means for controlling fluid positioned below the footrest.

15. An apparatus according to claim 1 wherein the lower extremity includes at least one foot.

16. An apparatus according to claim 1 wherein the lower extremity includes a foot and a lower leg

17. An apparatus according to claim 1 wherein the lower extremity includes a foot and a lower leg up to a knee.

18. An apparatus according to claim 1 wherein the lower extremity includes a foot and a lower leg up to and including a knee.

19. An apparatus according to claim 1 wherein the lower extremity includes a foot and a lower leg up to and including a knee and a thigh.

20. An apparatus according to claim 1 wherein the lower extremity includes a foot and a lower leg up to and including a knee and a thigh, and a hip.

21. An apparatus according to claim 1 wherein the lower extremity includes a foot and a lower leg up to and including a knee and a thigh, and a hip, and a waist.

22. A hydrotherapy apparatus for treating a lower extremity including a vessel adapted to retain a fluid, the vessel having an opening adapted to receive a lower extremity thereby allowing the user to contact the fluid, wherein the opening has a shape and/or size such that at least a portion of the fluid surface is covered.

23. An apparatus according to claim 22 wherein the vessel is adapted to reduce the amount of fluid loss from the vessel through splashing or turbulence by a jet.

24. An apparatus according to claim 22 wherein the vessel is adapted to cover at least about 20% of the fluid surface.

25. An apparatus according to claim 22 wherein the vessel is adapted to cover the entire fluid surface.

26. An apparatus according to claim 22 wherein the vessel includes a discrete vessel cover adapted to cover the opening.

27. An apparatus according to claim 26 including at least one aperture in the vessel cover adapted to receive at least one lower extremity thereby allowing the user to contact the fluid.

28. An apparatus according to claim 27 wherein the at least one aperture is provided with an aperture cover.

29. An apparatus according to claim 28 wherein the aperture cover is adapted to direct any fluid sloughed from the lower extremity away from the aperture.

30. An apparatus according to claim 28 wherein the aperture cover includes a resilient membrane having a slit adapted to allow a lower extremity to pass therethrough.

31. An apparatus according to claim 26 wherein the vessel cover is formed of a resilient membrane attached to the vessel, the resilient membrane further comprising at least one slit through which a lower extremity may pass upon entry into the vessel.

32. An apparatus according to claim 26 including means for circulating the fluid.

33. An apparatus according to claim 26 including at least one massaging jet.

34. An apparatus according to claim 33 wherein the jet is a high pressure jet.

35. An apparatus according to claim 33 wherein the jet is close to the fluid surface.

36. An apparatus according to claim 26 wherein the lower extremity includes at least one foot.

37. An apparatus according to claim 26 wherein the lower extremity includes a foot and a lower leg

38. An apparatus according to claim 26 wherein the lower extremity includes a foot and a lower leg up to a knee.

39. An apparatus according to claim 26 wherein the lower extremity includes a foot and a lower leg up to and including a knee.

40. An apparatus according to claim 26 wherein the lower extremity includes a foot and a lower leg up to and including a knee and a thigh.

41. An apparatus according to claim 26 wherein the lower extremity includes a foot and a lower leg up to and including a knee and a thigh, and a hip.

42. An apparatus according to claim 26 including means for controlling the temperature of the fluid.

43. An apparatus according to claim 42 wherein the means for controlling temperature is a heat exchanger capable of counteracting an increase in fluid temperature due to recirculation of the fluid.

44. An apparatus according to claim 26 including a flexible sheath adapted to receive a lower extremity or part thereof of the user

45. An apparatus according to claim 44 wherein the flexible sheath is resilient.

46. An apparatus according to claim 44 wherein the sheath has a multiwalled structure, having a cavity adapted to receive a fluid or a gas.

47. An apparatus according to claim 44 wherein the sheath has sufficient heat transfer properties so that the lower extremity of the user may be warmed or cooled as necessary.

48. An apparatus according to claim 44 wherein the sheath is generally cylindrical.

49. An apparatus according to claim 44 wherein the sheath is substantially trouser-shaped.

50. An apparatus according to claim 44 wherein the sheath is substantially sock-shaped

51. An apparatus according to claim 44 wherein the sheath is substantially boot-shaped.

52. An apparatus according to claim 44, further comprising means for controlling a fluid that has sloughed from the lower extremity.

53. A method of performing hydrotherapy on a lower extremity of a user, the method including use of an apparatus according to claim 1.

54. A method according to claim 53 wherein the lower extremity includes at least one foot.

55. A method according to claim 53 wherein the lower extremity includes a foot and a lower leg

56. A method according to claim 53 wherein the lower extremity includes a foot and a lower leg up to a knee.

57. A method according to claim 53 wherein the lower extremity includes a foot and a lower leg up to and including a knee.

58. A method according to claim 53 wherein the lower extremity includes a foot and a lower leg up to and including a knee and a thigh.

59. A method according to claim 53 wherein the lower extremity includes a foot and a lower leg up to and including a knee and a thigh, and a hip.

60. A method according to claim 53 wherein the temperature of the fluid is maintained at a substantially constant temperature.

61. (canceled)
